(19) United States
(12) Patent Application Publication
(10) Pub. No.: US 2024/0405973 A1
(43) Pub. Date: Dec. 5, 2024

(54) LOW BANDWIDTH ROTATION KEYS GENERATION FOR A HIERARCHICAL THREAT MODEL

(71) Applicant: International Business Machines Corporation, Armonk, NY (US)

(72) Inventors: Nir Drucker, Zichron Yaakov (IL); GUY MOSHKOWICH, Nes Ziyona (IL); Ramy Masalha, Kafr Qari (IL)

(21) Appl. No.: 18/327,102

(22) Filed: Jun. 1, 2023

(51) Int. Cl. H04L 9/08

(52) U.S. Cl. CPC H04L 9/0825; H04L 9/0861; H04L 9/0891

(57) ABSTRACT

A low bandwidth homomorphic encryption (HE) key generation method, a homomorphic encryption (HE) system, and a computer program product. One embodiment of the method comprises generating, at a principal instance of an organization unit, a principal HE key set; generating a department HE key set for each of a plurality of departments in the organization unit; transmitting a principal public key, a principal evaluation key, and a plurality of principal rotation keys to a data processor; transmitting at least one department public key, and department key switching keys to the data processor; and transmitting an encrypted data file to be processed at least in part using a department rotation key generated at the data processor.

### BACKGROUND

The present disclosure relates to homomorphic encryption, and more specifically, to low bandwidth rotation keys generation for a hierarchical threat model.

Homomorphic encryption (HE) generally refers to a type of encryption that allows computations to be performed on ciphertext while operating on the underlying plaintext homomorphically, without first decrypting the ciphertext into plain text. HE may be desirable because it allows data to be processed without making the inputs to and results of those computation(s) available to the data processor. For example, HE can be used in cloud computing, where a client organization can send confidential data to a remote server, which can then process that confidential data without ever being able to read the plaintext.

There are different types of homomorphic encryption, including fully homomorphic encryption (FHE), which allows any computation to be performed on encrypted data, and partially homomorphic encryption (PHE), which only allows specific types of computations to be performed on encrypted data.

### SUMMARY

One aspect of the disclosure is a low bandwidth homomorphic encryption (HE) key generation method. One embodiment of the method may comprise generating, at a principal instance of an organization unit, a principal HE key set, wherein the principal HE key set comprises a principal public key, a principal secret key, and a plurality of principal rotation keys. The embodiment may further comprise generating a department HE key set for each of a plurality of departments in the organization unit, wherein the set of department HE encryption keys each comprises a department public key, a department secret key, and department key switching keys. The embodiment may further comprise transmitting the principal public key, the principal evaluation key, and the plurality of principal rotation keys to a data processor. The embodiment may further comprise transmitting, by at least one of the plurality of departments to the data processor, at least one department public key, and department key switching keys to the data processor. The embodiment may further comprise transmitting, by the at least one of the plurality of departments to the data processor, an encrypted data file to be processed at least in part using a department rotation key generated at the data processor.

Another aspect of the disclosure is computer program product for low bandwidth homomorphic encryption (HE) processor. One embodiment may comprise a computer readable storage medium having program instructions embodied therewith. The program instructions may be executable by a processor to cause the processor to generate, at a principal instance of an organization unit, a principal HE key set, wherein the principal HE key set comprises a principal HE public key, a principal HE secret key, a principal HE evaluation key, and a plurality of principal HE rotation keys. The program instructions may further cause the processor to generate a department HE key set for each of a plurality of departments in the organization unit, wherein the set of department HE encryption keys each comprises a department HE public key, a department HE secret key, a department HE evaluation key, and a department HE key switching key. The program instructions may further cause the processor to transmit the principal public HE key, the principal HE evaluation key, and the plurality of principal HE rotation keys to a data processor. The program instructions may further cause the processor to transmit, by at least one of the plurality of departments to the data processor, at least one department public HE key, department evaluation key, and department key switching HE key to the data processor. The program instructions may further cause the processor to transmit, by the at least one of the plurality of departments to the data processor, an encrypted data file to be processed at least in part using a department HE rotation key generated at the data processor.

Another aspect of the disclosure is a homomorphic encryption (HE) system. One embodiment of the system may comprise at least one processor configured to execute program instructions that, when executed on the processor, cause the processor to generate, at a principal instance of an organization unit, a principal HE key set, wherein the principal HE key set comprises a principal HE public key, a principal HE secret key, a principal HE evaluation key, and a plurality of principal HE rotation keys. The system may further comprise instructions that cause the processor to generate a department HE key set for each of a plurality of departments in the organization unit, wherein the set of department HE encryption keys each comprises a department HE public key, a department HE secret key, a department HE evaluation key, and a department HE key switching key. The system may further comprise instructions that cause the processor to transmit the principal public HE key, the principal HE evaluation key, and the plurality of principal HE rotation keys to a data processor. The system may further comprise instructions that cause the processor to transmit, by at least one of the plurality of departments to the data processor, at least one department public HE key, department evaluation key, and department key switching HE key to the data processor. The system may further comprise instructions that cause the processor to transmit, by the at least one of the plurality of departments to the data processor, an encrypted data file to be processed at least in part using a department HE rotation key generated at the data processor.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 is a block diagram that depicts an example environment for the execution of at least some of the computer code involved in performing the disclosed methods, such as homomorphic encryption processor.

FIG. 2 is a block diagram of an example, non-limiting architecture that facilitates provision a data processing service by a remote service provider in accordance with one or more embodiments described herein.

FIG. 3A-3B is a block diagram illustrating an example, non-limiting transmission of a homomorphic encryption key set from an organization unit to a data processor in accordance with one or more embodiments described herein.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure relate to homomorphic encryption; more particular aspects relate low bandwidth rotation keys generation for a hierarchical threat model. While the present disclosure is not necessarily limited to such applications, various aspects of the disclosure may be appreciated through a discussion of various examples using this context.

A data service provider is an organization unit, typically a company, that offers various services related to data, such as computation and data storage. The data service can include, but is not limited to, a computation service, a recommendation service, a data analytics service, a data mining service, a financial analysis service, a marketing analysis service, a pricing analysis service, a forecasting analysis service, a parameter tuning service, a testing analysis service, or any other suitable computing service that can be provided as a remote service over a network. In this way, data service providers can help clients (e.g., other businesses and consumers) access and use data on demand, regardless of their location, over a network, such as the Internet.

Typically, the data service provider provides their service(s) remotely via a plurality of data processing systems (“DPS”), e.g., a rack of high powered server computers, which in turn, may be organized into a cloud computing system. The client's DPS can access the provider's remote DPS across the Internet by sending input data and receiving output data generated by e.g., a computation service of the data service provider. For example, the client can employ a remote computation service to analyze sales data and provide recommendations on target demographics for marketing and/or sales forecasts. In another example, a client can employ a remote computation service to analyze production data and to provide process improvement recommendations and/or production forecasts. In another example, a client can employ a remote computation service that analyzes cost and pricing data and provides recommendations on product pricing. In some cases, the client can pay a defined fee for the remote computation service for a defined set of input data. In other cases, the client can pay a fee based on the actual computing resources consumed by the data processing request.

In some cases, however, a client may be hesitant to transmit sensitive and/or confidential input data (e.g., sensitive customer data, sales data, financial data, marketing data, pricing data, inventory data, etc.) to a third party and/or allow broad access to that data by anyone without a strict need-to-know (e.g., by the client's own information-technology staff).

For example, a client that wants to employ the computation service may be legally restricted from providing sensitive customer data to the computation service. In another example, the client might be fearful of transmitting the input data to the remote computation service over a public or private network due to concerns over a third party intercepting the input data during transmission or upon arrival at a device associated with the remote computation service. In still another example, a department of a hospital may want to restrict information about high profile patients to the care team.

To address the challenge of providing a computation service while keeping client data private, some embodiments of the present disclosure may employ a cryptosystem that utilizes homomorphic encryption (HE) cryptosystem to enable a data service provider to evaluate a circuit/function on encrypted data. In some embodiments, the HE cryptosystem may enable one or more of the following four methods: generate random public/secret key-pair (“Gen”), encrypt a message with the public key (“Enc”), decrypt a ciphertext with the secret key (“Dec”), and evaluate a circuit/function on the ciphertext (“Eval”) (described in more detail below).

Advantageously, the data service provider does not need access to the unencrypted data or the secret decryption key to perform the Eval method on the data.

More specifically, the client in some embodiments may use the Gen method to generate a pair of secret and public keys (“sk,” “pk”). The client may store the private key and may publish the public key. Using pk, the user can encrypt sensitive data “mi” by calling ci=Enc_pk(mi). Subsequently, the user can ask the untrusted entity to execute the function c_res=Eval_pk(f,(c1, . . . , cn)) in order to evaluate a function “f” on some ciphertexts “ci” and store the results in another ciphertext “c_res.” To decrypt c_res using sk, the client may call m_res=Dec_sk(c_res). The HE cryptosystem in some embodiments is correct when m=Dec(Enc(m)) and is approximately correct when m=Dec(Enc(m))+epsilon, for some relatively small epsilon.

In practice, however, one issue with such a HE cryptosystem is the size of the associated keys. For example, in some HE cryptosystem embodiments, the keys comprise a vector of polynomials from the ring: Z_q[X]/X\hat{ }N+1 (where N is a power of two), and thus, the keys are often on the order of several megabytes (MB) in size. For example, in an embodiment where N=2\hat{ }32 and q=881, the secret key size will be approximately 5.2 MB in size and the public key will be approximately 10.4 MB in size. Additionally, many HE cryptosystem embodiments may also utilize additional keys used during evaluation on the cloud side, such as evaluation keys (of size ˜200 MB) and rotation keys (of size ˜5.6 GB). The transmission of multiple sets of such keys from the client to the data service provider will consume considerable time and bandwidth, which may reduce the practicality of “ephemeral” HE cryptosystems (i.e., system in which the keys are frequently changed, possibly as often as every evaluation) in many solutions. This issue can be further magnified when the client organization unit wishes to compartmentalize data (e.g., according to need-to-know principles) among its internal organization units, such as departments, as each internal organization unit traditionally used its own set of keys.

Accordingly, one aspect of this disclosure is a security model for a HE cryptosystem that optimizes its threat model with respect to bandwidth costs. In particular, some embodiments in this disclosure may trade the online uploading phase of many rotations sets to the data processor with a stream-lined threat model that leverages inter-organizational controls to reduce bandwidth and latency costs of associated with transmitting HE keys sets to the data processing service. Some embodiments may leverage this advantage to enable department-level ephemeral HE e.g., using Cheon-Kim-Kim-Song (CKKS) rotation keys. That is, some embodiments of the disclosure may leverage inter-organizational control to reduce the bandwidth necessary to implement department-level ephemeral HE.

For example, an organization unit (“Org”), such as a hospital, may desire to use a cloud-based data processing service for computation, but is subject to data privacy laws/rules e.g., the General Data Protection Regulations (“GPDR”), the Health Insurance Portability and Accountability Act (“HIPPA”). Thus, Org may want, or even need, to achieve data separation among its different internal organizational units/departments (D1-Dn, or collectively “Depts”) by using different HE instances (i.e., each instance using a different set of keys, also known as key separation). Conventionally, this would require that Org upload many sets of very large rotation keys to the Cloud, one set for each Dept. In particular, in these conventional systems, four scenarios were employed:
a) Org-level-static mode: Org generates one static set of keys (secret key “sk,” public key “pk,” evaluation key “e1,” rotations key(s)s “r1”) and uploads the keys pk, e1, and r1 to the cloud once, up-front. In this conventional scenario, the entire Org used the same keys for a long period. While the bandwidth costs were low, the attack surface was large because many different Depts in the Org have access to sk for decrypting data and, even if only one component is responsible to serve as a gateway in the system, the Dept that manages the gateway may obtain data of other Depts, which violates need-to-know principles.
b) Org-level-ephemeral mode: Org generates many sets of keys (secret keys “sk_j,” public keys “pk_j,” evaluation keys “e_j,” and rotation keys r_j). Org then uploads pk_j, e_j, and r_j to the Cloud. Here, the entire Org uses the same key(s) only for a short time period, i.e., the attack surface is lower than in scenario (a) above, but the bandwidth costs are many times higher. Also again in this scenario, if two or more Depts share keys, private data may leak between those Depts, again violating need-to-know principles.
c) Dept-level-static mode: Each Dept generates its own set of keys (secret keys “sk_j,” public keys “pk_j,” evaluation key “e_j,” and rotation keys “r_j”) and each Dept uploads keys pk_j, e_j, and r_j to the Cloud. In this scenario, every Dept uses its keys for a long period, which increases the attack surface. Additionally, the bandwidth costs are high.
d) Dept-level-ephemeral mode: Each Dept generates its own set of keys (secret key “sk_j,” public key “pk_j,” evaluation key “e_j,” and rotation keys “r_j”) per computation, and then each Dept uploads pk_j, e_j, and r_j to the Cloud. Here, every Dept uses its key(s) for only a short period, which reduces the attack surface, but the bandwidth cost for this scenario is dramatically increased as compared to the scenarios a, b, and c.
   Some embodiments of this disclosure, in contrast to these conventional scenarios, permit the Org to define a principal instance, where only that principal instance uploads rotation keys to the data service provider (e.g., cloud). The other Depts in Org may then rely on the principal instance's rotation keys by using key-switching-keys (KSK) to generate their respective rotation keys offline. Advantageously in some embodiments, the private key of the principal instance is never transmitted to the data service provider. Thus, the data service provider cannot decrypt any data. Additionally, if the Org can assume that the principal instance does not collude with the data service provider and in particular, does not receive any information from it during the lifetime of the secret key (e.g., because the principal instance is owned/controlled by the Org), the Org can be confident that the principal instance also cannot see data belonging to the Org's different Depts. Alternatively, in some embodiments, the principal instance may be located inside a Trusted Component Base (TCB) of the Depts, which may still reduce the attack surface compared to a solution that uses only one instance for the entire Org.

Rotation keys in some embodiments may enable allow rotating the underlying vector. For example, when encrypting a vector of values (as some HE cryptosystem embodiments allow, particularly those that support Single Instruction Multiple Data (SIMD) operations):
Let v=(1,2,3,4,5,6); its encryption is c=Enc(v) and it follows that after rotating by 1 and decrypting we get w=Dec(Rot_1(c))=(2,3,4,5,6,1). If this example rotates by 3, it gets w=Dec(Rot_3(c))=(4,5,6,1,2,3). Different rotation keys enable different rotations.
   There can be “n” (i.e., the size of the maximal vector that a ciphertext can hold) rotation keys in some embodiments.

Rotation keys may also be desirable in some embodiments for certain bootstrapping operations that enable further computation on a HE ciphertext. For example, to move a ciphertext from one key to another, some embodiments may utilize two or more key switching keys. In some embodiments, KSK may, itself, comprise a rotation key.

In some embodiments, the Org may implement two components: (i) HEkeygen_local, instantiated locally in the principal instance on Org premises/on an Org-controlled DPS, and (ii) HEkeygen_cloud, instantiated remotely at the remote data service provider “Cloud.” HEkeygen_local, in turn, may include the following application programming interfaces (“APIs”):
a) GeneratePrincipleKeys: generates a principle set of keys (secret key “sk1,” public key “pk1,” evaluation key “evaluation1,” and rotation keys “rotations1”);
b) UploadPrincipleKeys: uploads (public key “pk1,” evaluation key “evaluation1,” and rotation keys “rotations1”) to HEkeygen_cloud; and
c) GenerateEphemeralKeys: generates an ephemeral set of keys K (secret key “sk,” public key “pk,” evaluation key “evaluation1,” skA=switchKey_{sk→sk1,}, skB=switchKey_{sk1→sk}). GenerateEphemeralKeys returns K without storing it.
   Upon initialization, Org may call GeneratePrincipleKeys and UploadPrincipleKeys to generate and upload the principle set of keys to the Cloud. The keys may also be stored locally. Subsequently, every Dept (i.e., D1, . . . , Dn) can ask Org to generate a new set of keys for a short/long period by calling GenerateEphemeralKeys. GenerateEphemeralKeys, in turn, may store sk locally and may upload the rest of the keys (i.e., public/evaluation, but not rotation) to Cloud. Advantageously, in this embodiment, only the relevant Dept has access to these keys.

The HEkeygen_cloud component may have the following API:
GenerateRotationKeys: receives (public key “pk,” key switching key sk1→sk (KSKa), key switching key sk→sk1 (KSKb) and a list of indices of rotations “i”). For every rotation index i in the input list, GenerateRotationKeys generates the requested rotation key by rotating KSKa using the relevant key from the rotation1 key set and applying key-switching from secret key “sk1” to secret key “sk” by using key switching key sk→sk1. The resulting rotation keys are sent back to the requester.
   Advantageously, in some embodiments, the large rotation keys only need to be sent only once, instead of many times in the conventional security models described above, and may be generated on-the-fly, possibly in-parallel. Another advantage is that, because encrypted data is not shared between Depts and HEkeygen_cloud (i.e., only the keys are shared) in some embodiments, the HEkeygen_cloud component in these embodiments cannot collect and/or decrypt encrypted data. Another advantage of some embodiments is that, if the HEkeygen_cloud component does not have other APIs other than the one defined above, and if HEkeygen_cloud deletes the switching keys, Org may be assured that HEkeygen_cloud has no way to transform encryptions of data even if it gets to see the data from sk to sk1 or vice-versa. In some embodiments, ensuring deletion of the key switching keys may be enabled by organizational controls. In other embodiments, ensuring deletion may be enabled by vetting the Cloud code and receiving an integrity guarantee (e.g., when Cloud runs the vetted code under a Trusted Execution Environment (TEE), such as Intel Software Guard Extensions (SGX), or when Microsoft Trusted Platform Module (TPM) is used).

Additionally, because the HEkeygen_local component is responsible to generate the private keys in some embodiments, it already should be able to decrypt all data; however, assuming the HEkeygen_local component has no API to get this data, it may be considered secure. Alternatively, in some embodiments, the various Depts (i.e., D1, . . . , Dn) may each generate their keys locally, and by that, avoid providing the secret key to the HEkeygen_local components. These embodiments, however, should implement controls to ensure that there is no API to send switch key skB from HEkeygen_cloud to HEkeygen_local. The error added during the rotation keys generation process equals the error added in one rotation and one key switching, which is acceptable for most purposes.

Turning now to the Figures, various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example environment for the execution of at least some of the computer code involved in performing the inventive methods, such as a homomorphic encryption processor (HE processor) 204 or HE processor 205. In addition to the homomorphic encryption processor (HE processor) 204/205, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 204/205, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

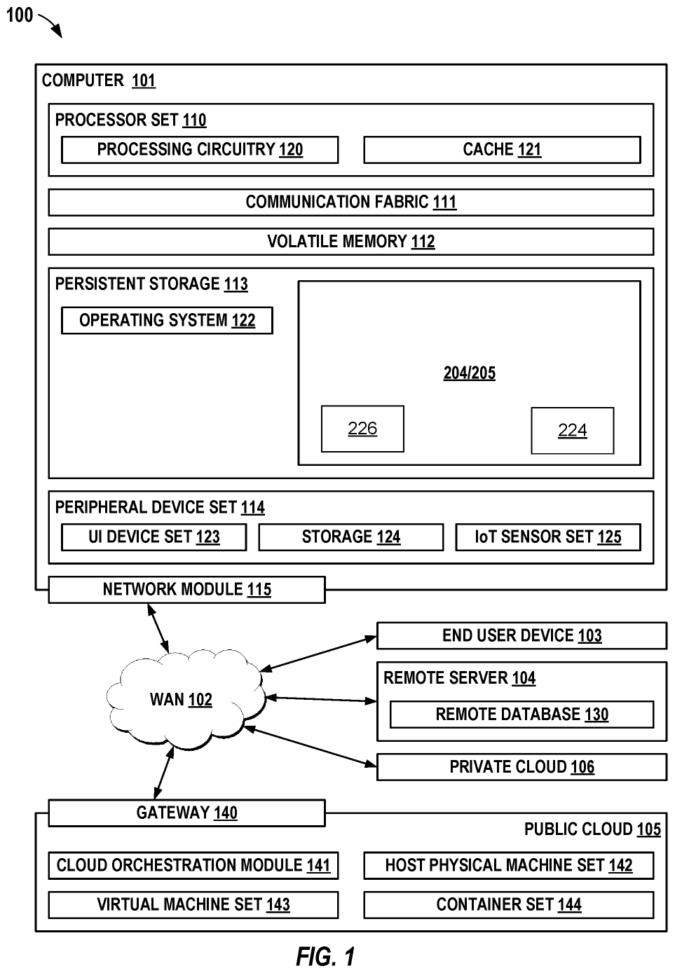

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in blocks 204/205 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

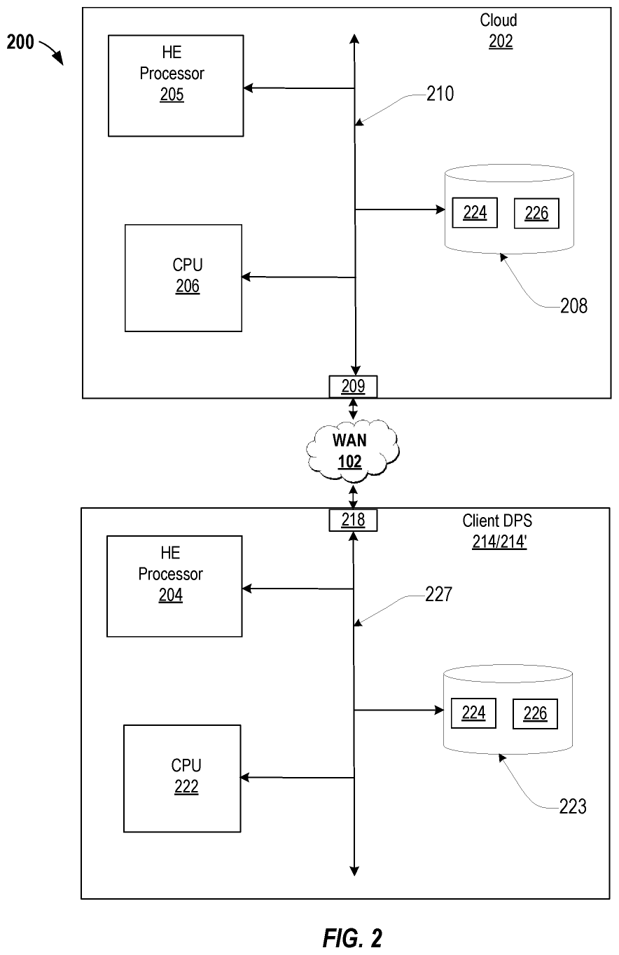

FIG. 2 is a block diagram of an example, non-limiting architecture 200 that facilitates provision a data processing service by a remote data service provider in accordance with one or more embodiments described herein. As shown in FIG. 2, the architecture 200 may include a cloud environment 202 (“Cloud”), such as public cloud 105 or private cloud 106; one or more networks 212, such as WAN 102; and one or more client data processing systems (DPS) 214 associated with a client organization unit. The client DPS 214 and the cloud 202, in turn, may each include an homomorphic encryption processor (HE processor) 204, 205 that can facilitate information processing on behalf of a client organization unit on a defined set of encrypted input data 224 (e.g., ciphertext) using a homomorphic key set 226.

The cloud 202 may further include at least one memory 208 that can store computer executable components to receive encrypted data and/or encryption keys from the client DPS 214, store any intermediate calculations and/or results generated by the HE processor 204 and associated components. Cloud 202 may further include or otherwise be associated with at least one central processing unit (“CPU,” also known as a “processor”) 206 that may execute the computer executable components stored in memory 208, and a network interface 209. These computer instructions may cause the CPU 206 to implement the HE processor 205 (including the previously-described HEkeygen_cloud component). Cloud 202 may further include a system bus 210 that can communicatively couple various subcomponents of the cloud 202, including, but not limited to, the memory 208, the network interface 209, and the CPU 206.

Each of the one or more of client DPS 214 may be associated an organization unit 220 (“Org”). The Org may define one of the plurality of client DPS 214 (or a logical partition thereof) as a principal instance 214′. The remaining client DPS 214 (or logical partitions thereof) may each be assigned to an internal organizational unit (“Dept”) inside the organization unit 220. The client device 214 can also include or otherwise be associated with at least one CPU 222 that may execute computer executable components stored in a memory 223, and a network interface 218. The computer executable components may include, but are not limited to, the HE processor 204 (including the previously described HEkeygen_local component) and encrypted input data 224. Client device 214 may further include a system bus 227 that can couple the various subcomponents of the client device 214, including, but not limited to, the network interface 218, the memory 223, and/or the CPU 222.

In operation, HE processor 204 may obtain encrypted input data 224 on which Org would like a computation service to be performed by HE processor 205. HE processor 204 can prepare the encrypted input data 224 for encryption by scaling (e.g., rounding, truncating, or any other suitable scaling mechanism) any (or, in some embodiments, one or more) values in the encrypted input data 224 that are not whole integers into whole integers to generate a set of prepared input data. The HE processor 204 may then encrypt the prepared encrypted input data 224 using a homomorphic encryption public key 226pk to generate a set of encrypted input data 224. The HE processor 204 may transmit the encrypted input data 224 to the Cloud 202 over the network 212. The HE processor 205 on the Cloud may process the encrypted input data 224 using an homomorphic encryption evaluation key 226e and/or homomorphic encryption rotation keys 226r. In some embodiments, the encrypted input data 224 and the homomorphic encryption key set 226 may be transmitted as separate transmissions. In other embodiments, the homomorphic encryption key set 226 and encrypted input data 224 may be transmitted together from client DPS 214 to the Cloud 202.

It is to be appreciated that cloud environment 202 may be associated with a data processing service provider that provides data processing services to the Org on a defined set of input data 224 in encrypted form i.e., without ever decrypting the input data 224 into plain text.

Accordingly, embodiments of the present disclosure may be delivered as part of a service engagement with a client corporation, nonprofit organization, government entity, internal organizational structure, or the like. These embodiments may include configuring a computer system to perform, and deploying software, hardware, and web services that implement, some or all of the methods described herein. These embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems.

The various components (e.g., cloud environment 202 and client devices 214) of architecture 200 can be connected either directly or via one or more networks 212. Such networks 212 can include wired and wireless networks, including, but not limited to, a cellular network, a wide area network (WAN) (e.g., the Internet), or a local area network (LAN), non-limiting examples of which include cellular, WAN, wireless fidelity (Wi-Fi), Wi-Max, WLAN, radio communication, microwave communication, satellite communication, optical communication, sonic communication, or any other suitable communication technology.

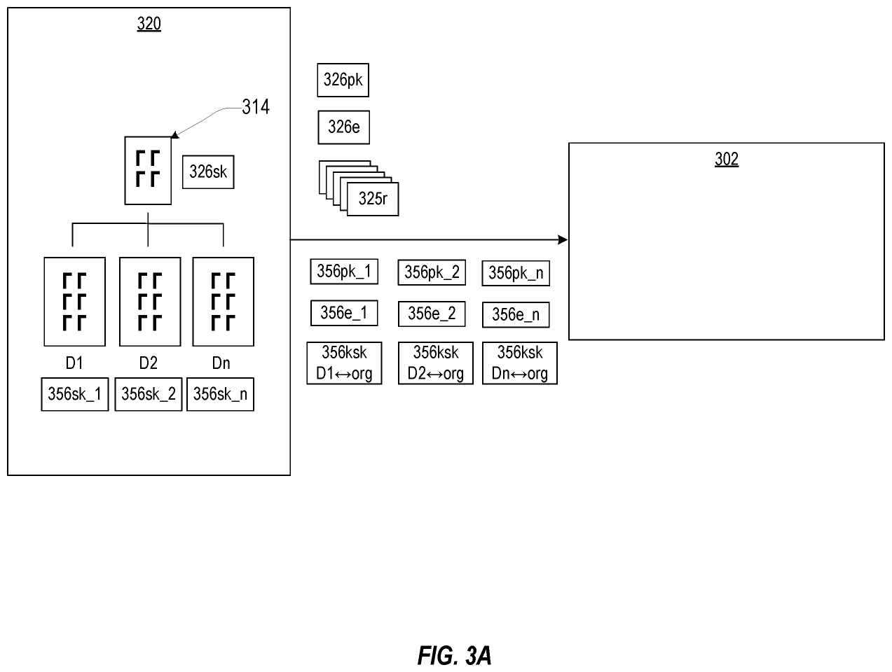

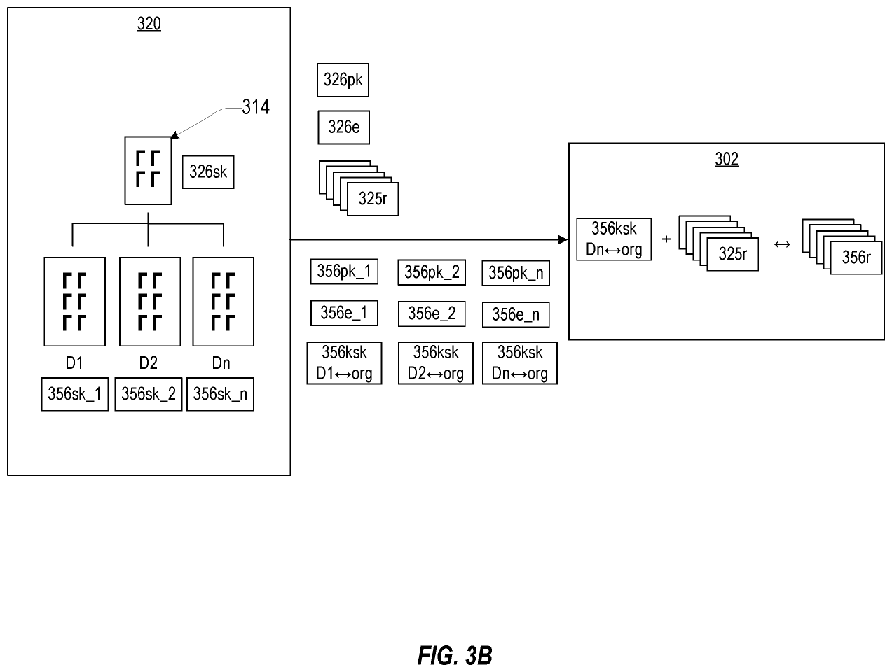

FIG. 3A-3B is a block diagram illustrating an example, non-limiting transmission of a HE key set from an organization unit to a data processor in accordance with one or more embodiments described herein. Repetitive description of like elements employed in other embodiments described herein is omitted for sake of brevity.

In FIG. 3A, Org 320 may generate a HE private key 326sk, a HE public key 326pk, a He evaluation key 326e, and a plurality of HE rotation keys 325r for the principal instance 314 using, e.g., using HEkeygen_local component. Org 320 may then transmit the HE public key 326pk, the HE evaluation key 326e, and the plurality of HE rotation keys 326r for the principal instance 350 to the Cloud 302. Separately, the each of the various departments D1, . . . , Dn of Org 320 may each request their own set of HE private keys 356sk_n, HE public keys 356pk_n, and HE key switching keys 356ksk_{Dn↔Org} from the principal instance 314. Each department D1, . . . , Dn may then transmit their respective HE public keys 356pk_1, . . . , 356pk_n and HE key switching keys 356ksk_{D1↔Org}, . . . , 356ksk_{Dn↔Org} to the cloud 302. Advantageously, the HE key switching keys switching keys 356ksk_{D1↔Org}, . . . , 356ksk_{Dn↔Org} are significantly smaller in size than a set of HE rotation keys.

In FIG. 3B, the Cloud 302 may generate a plurality of rotation key sets 356r_1, . . . 356r_n for each of the departments D1, . . . , Dn using the set of rotation keys 326r for the Org and each departments' respective HE key switching key 356ksk_{D1↔Org}, . . . , 356ksk_{Dn↔Org}. The cloud 302 may then use the respective sets rotation keys 356r_1, . . . , 356r_n to evaluate encrypted input data 324 from the respective department D1, . . . , Dn. Cloud environment 302 does not have homomorphic encryption private key for either the Org or the Depts, and therefore, cannot decrypt encrypted input data 324.

A non-limiting list of examples are provided hereinafter to demonstrate some aspects of the present disclosure. Example 1 is a low bandwidth homomorphic encryption (HE) key generation method. One embodiment of the method may comprise generating, at a principal instance of an organization unit, a principal HE key set, wherein the principal HE key set comprises a principal public key, a principal secret key, and a plurality of principal rotation keys. The embodiment may further comprise generating a department HE key set for each of a plurality of departments in the organization unit, wherein the set of department HE encryption keys each comprises a department public key, a department secret key, and department key switching keys. The embodiment may further comprise transmitting the principal public key, the principal evaluation key, and the plurality of principal rotation keys to a data processor. The embodiment may further comprise transmitting, by at least one of the plurality of departments to the data processor, at least one department public key, and department key switching keys to the data processor. The embodiment may further comprise transmitting, by the at least one of the plurality of departments to the data processor, an encrypted data file to be processed at least in part using a department rotation key generated at the data processor.

Example 2 is computer program product for low bandwidth homomorphic encryption (HE) processor. One embodiment may comprise a computer readable storage medium having program instructions embodied therewith. The program instructions may be executable by a processor to cause the processor to generate, at a principal instance of an organization unit, a principal HE key set, wherein the principal HE key set comprises a principal HE public key, a principal HE secret key, a principal HE evaluation key, and a plurality of principal HE rotation keys. The program instructions may further cause the processor to generate a department HE key set for each of a plurality of departments in the organization unit, wherein the set of department HE encryption keys each comprises a department HE public key, a department HE secret key, a department HE evaluation key, and a department HE key switching key. The program instructions may further cause the processor to transmit the principal public HE key, the principal HE evaluation key, and the plurality of principal HE rotation keys to a data processor. The program instructions may further cause the processor to transmit, by at least one of the plurality of departments to the data processor, at least one department public HE key, department evaluation key, and department key switching HE key to the data processor. The program instructions may further cause the processor to transmit, by the at least one of the plurality of departments to the data processor, an encrypted data file to be processed at least in part using a department HE rotation key generated at the data processor.

Example 3 is a homomorphic encryption (HE) system. One embodiment of the system may comprise at least one processor configured to execute program instructions that, when executed on the processor, cause the processor to generate, at a principal instance of an organization unit, a principal HE key set, wherein the principal HE key set comprises a principal HE public key, a principal HE secret key, a principal HE evaluation key, and a plurality of principal HE rotation keys. The system may further comprise instructions that cause the processor to generate a department HE key set for each of a plurality of departments in the organization unit, wherein the set of department HE encryption keys each comprises a department HE public key, a department HE secret key, a department HE evaluation key, and a department HE key switching key. The system may further comprise instructions that cause the processor to transmit the principal public HE key, the principal HE evaluation key, and the plurality of principal HE rotation keys to a data processor. The system may further comprise instructions that cause the processor to transmit, by at least one of the plurality of departments to the data processor, at least one department public HE key, department evaluation key, and department key switching HE key to the data processor. The system may further comprise instructions that cause the processor to transmit, by the at least one of the plurality of departments to the data processor, an encrypted data file to be processed at least in part using a department HE rotation key generated at the data processor.

Example 4 includes the features of any of Examples 1-3. In this example, a plurality of department HE rotation keys are generated at the data processor from the plurality of principal HE rotation keys and the department key switching keys.

Example 5 includes the features of any of Examples 1-4. In this example, the data processor is enabled to perform calculations on the encrypted data file using the department HE rotation keys.

Example 6 includes the features of any of Examples 1-5. In this example, the department HE rotation keys permit each calculation of the encrypted data file to use a different key.

Example 7 includes the features of any of Examples 1-6. In this example, the department key set is generated at the principal instance of the organization unit.

Example 8 includes the features of any of Examples 1-7. In this example, the principal instance of the organization unit comprises a HEkeygen_local component that comprises a plurality of application programming interfaces (“APIs”), including:
(i) a GeneratePrincipleKeys API adapted to generate a principle set of HE keys;
(ii) a UploadPrincipleKeys API adapted to upload the principal set of HE keys to a HEkeygen_cloud component of the remote data provider; and
(iii) a GenerateEphemeralKeys API adapted to generate an ephemeral set of HE keys without storing it.

Example 9 includes the features of any of Examples 1-8. In this example, the HEkeygen_cloud component of the remote data provider comprises a GenerateRotationKeys API adapted to receive a set of HE keys and, for every rotation index i in an input list, generates at least one HE rotation key.

Example 10 includes the features of any of Examples 1-9. This example further comprises ensuring that the HEkeygen_cloud component HEkeygen_cloud deletes the switching keys after use.

Example 11 includes the features of any of Examples 1-10. In this example, the data processor comprises an untrusted cloud computing provider.

Example 12 includes the features of any of Examples 1-11. In this example, the principal HE key set further comprises a principal HE evaluation key, the sets of department HE encryption keys each further comprise a department HE evaluation key, and the department HE key switching keys comprise a dept-to-org key switching key and an org-to-dept key switching key.

### GENERAL

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A low bandwidth homomorphic encryption (HE) key generation method, comprising:
generating, at a principal instance of an organization unit, a principal HE key set, wherein the principal HE key set comprises a principal public key, a principal secret key, and a plurality of principal rotation keys;
generating a department HE key set for each of a plurality of departments in the organization unit, wherein the set of department HE encryption keys each comprises a department public key, a department secret key, and department key switching keys;
transmitting the principal public key, the principal evaluation key, and the plurality of principal rotation keys to a data processor;
transmitting, by at least one of the plurality of departments to the data processor, at least one department public key, and department key switching keys to the data processor; and
transmitting, by the at least one of the plurality of departments to the data processor, an encrypted data file to be processed at least in part using a department rotation key generated at the data processor.

2. The method of claim 1, wherein a plurality of department HE rotation keys are generated at the data processor from the plurality of principal HE rotation keys and the department key switching keys.

3. The method of claim 2, wherein the data processor is enabled to perform calculations on the encrypted data file using the department HE rotation keys.

4. The method of claim 3, wherein the department HE rotation keys permit each calculation of the encrypted data file to use a different key.

5. The method of claim 1, wherein the department key set is generated at the principal instance of the organization unit.

6. The method of claim 5, wherein the principal instance of the organization unit comprises a HEkeygen_local component that comprises a plurality of application programming interfaces (“APIs”), including:
(i) a GeneratePrincipleKeys API adapted to generate a principle set of HE keys;
(ii) a UploadPrincipleKeys API adapted to upload the principal set of HE keys to a HEkeygen_cloud component of the remote data provider; and
(iii) a GenerateEphemeralKeys API adapted to generate an ephemeral set of HE keys without storing it.

7. The method of claim 6, wherein the HEkeygen_cloud component of the remote data provider comprises a GenerateRotationKeys API adapted to receive a set of HE keys and, for every rotation index i in an input list, generates at least one HE rotation key.

8. The method of claim 7, further comprising ensuring that the HEkeygen_cloud component HEkeygen_cloud deletes the switching keys after use.

9. The method of claim 1, wherein the data processor comprises an untrusted cloud computing provider.

10. The method of claim 1, wherein:
the principal HE key set further comprises a principal HE evaluation key;
the sets of department HE encryption keys each further comprise a department HE evaluation key; and
the department HE key switching keys comprise a dept-to-org key switching key and an org-to-dept key switching key.

11. A computer program product for low bandwidth homomorphic encryption (HE) processor, comprising a computer readable storage medium having program instructions embodied therewith, the program instructions executable by a processor to cause the processor to:
generate, at a principal instance of an organization unit, a principal HE key set, wherein the principal HE key set comprises a principal HE public key, a principal HE secret key, a principal HE evaluation key, and a plurality of principal HE rotation keys;
generate a department HE key set for each of a plurality of departments in the organization unit, wherein the set of department HE encryption keys each comprises a department HE public key, a department HE secret key, a department HE evaluation key, and a department HE key switching key;
transmit the principal public HE key, the principal HE evaluation key, and the plurality of principal HE rotation keys to a data processor;
transmit, by at least one of the plurality of departments to the data processor, at least one department public HE key, department evaluation key, and department key switching HE key to the data processor; and
transmit, by the at least one of the plurality of departments to the data processor, an encrypted data file to be processed at least in part using a department HE rotation key generated at the data processor.

12. A homomorphic encryption (HE) system, comprising at least one processor configured to execute program instructions that, when executed on the processor, cause the processor to:
generate, at a principal instance of an organization unit, a principal HE key set, wherein the principal HE key set comprises a principal HE public key, a principal HE secret key, a principal HE evaluation key, and a plurality of principal HE rotation keys;
generate a department HE key set for each of a plurality of departments in the organization unit, wherein the set of department HE encryption keys each comprises a department HE public key, a department HE secret key, a department HE evaluation key, and a department HE key switching key;
transmit the principal public HE key, the principal HE evaluation key, and the plurality of principal HE rotation keys to a data processor;
transmit, by at least one of the plurality of departments to the data processor, at least one department public HE key, department evaluation key, and department key switching HE key to the data processor; and
transmit, by the at least one of the plurality of departments to the data processor, an encrypted data file to be processed at least in part using a department HE rotation key generated at the data processor.

13. The system of claim 12, wherein:
a plurality of department HE rotation keys are generated at the data processor from the plurality of principal HE rotation keys and the department key switching keys; and
the data processor is enabled to perform calculations on the encrypted data file using the department HE rotation keys.

14. The system of claim 13, wherein the department HE rotation keys permit each calculation of the encrypted data file to use a different key.

15. The system of claim 12, wherein the department key set is generated at the principal instance of the organization unit.

16. The system of claim 15, wherein the principal instance of the organization unit comprises a HEkeygen_local component that comprises a plurality of application programming interfaces (“APIs”), including:
(i) a GeneratePrincipleKeys API adapted to generate a principle set of HE keys;
(ii) a UploadPrincipleKeys API adapted to upload the principal set of HE keys to a HEkeygen_cloud component of the remote data provider; and
(iii) a GenerateEphemeralKeys API adapted to generate an ephemeral set of HE keys without storing it.

17. The system of claim 16, wherein the HEkeygen_cloud component of the remote data provider comprises a GenerateRotationKeys API adapted to receive a set of HE keys and, for every rotation index i in an input list, generates at least one HE rotation key.

18. The system of claim 17, further comprising program instructions to ensure that the HEkeygen_cloud component HEkeygen_cloud deletes the switching keys after use.

19. The system of claim 10, wherein the data processor comprises an untrusted cloud computing provider.

20. The system of claim 10, wherein:
the principal HE key set further comprises a principal HE evaluation key;
the sets of department HE encryption keys each further comprise a department HE evaluation key; and
the department HE key switching keys comprise a dept-to-org key switching key and an org-to-dept key switching key.
